(19) United States
(12) Patent Application Publication
(10) Pub. No.: US 2006/0238742 A1
(43) Pub. Date: Oct. 26, 2006

(54) Short duty cycle lidar

(76) Inventors: Jeffrey H. Hunt, Thousand Oaks, CA (US); Peter Wittenberg, Creve Coeur, MO (US)

Correspondence Address: MACPHERSON KWOK CHEN & HEID LLP, 1762 TECHNOLOGY DRIVE, SUITE 226, SAN JOSE, CA, 95110, US

(21) Appl. No.: 11/114,731

(22) Filed: Apr. 25, 2005

(51) Int. Cl. G01C 3/08; G01S 13/00

(52) U.S. Cl. 356/5.15; 356/5.01; 356/5.14; 356/5.11

(57) ABSTRACT

A method and system of frequency tagging lidar light signals is disclosed. An optical synthesizer can be used to provide a sequence of frequency tagged light signals so as to substantially mitigate ambiguity associated with received light signals. This results in a desirable reduction in the duration of a duty cycle of the lidar system, thus enhancing the resolution of the lidar system.

### TECHNICAL FIELD

The present invention relates generally to optics and, more particularly, to a method and system for providing lidar having a short duty cycle.

### BACKGROUND

Lidar is a optical form of radar. Thus, instead of using radio frequency signals, lidar uses optical signals such as a those produced by a laser. In a lidar system, a pulse of light is transmitted and the distance to the target is determined from the round trip time of the light pulse. That is, the distance to the target is proportional to the time that it takes the transmitted light pulse to reach the target plus the time that it takes the return pulse reflected from the target to reach the lidar receiver.

A series of pulses can be scanned across an scene to provide a range image of the scene. Lidar has the potential to provide very accurate and very detailed ranging information.

However, contemporary lidar systems suffer from the deficiency of requiring long duty cycles. A duty cycle for a lidar system, as the term is used herein, is defined as the time between the transmission of two consecutive light pulses. Long duty cycles are necessary to prevent ambiguity in multiple pulse reception.

If a later pulse is transmitted before an earlier pulse is received, then it is possible for the receiver to confuse the two pulses. The later transmitted pulse could be reflected from a closer target and thus arrive back at the receiver before the earlier transmitted pulse. The receiver of a contemporary lidar system has no way of knowing that the later pulse was received first and therefore provides incorrect range information for the two pulses.

Although long duty cycles tend to prevent such ambiguity, they substantially reduce the pulse rate at which lidar operates. Reduced pulse rate translates into reduced detail in the range image, since the amount of range information that can be obtained in a given period of time is similarly reduced.

As a result, there is a need for a way to mitigate ambiguity in lidar systems such that shorter duty cycles can be used and more detail can thus be provided.

### SUMMARY

A method and system of frequency tagging lidar signals is disclosed. An optical synthesizer can be used to provide a sequence of frequency tagged light signals so as to substantially mitigate ambiguity associated with received light signals. This results in a desirable reduction in the duration of a duty cycle of the lidar system, thus enhancing the resolution of the lidar system.

More specifically, in accordance with one embodiment of the present invention, the optical synthesizer comprises at least one laser source, a local radio frequency oscillator (such as a microwave frequency local oscillator) and a mixer configured to mix the outputs of the laser source(s) and the local radio frequency oscillator in a manner that forms a plurality of output light signals. Each of the output light signals has a different frequency and is thus tagged such that it can later be recognized.

In accordance with one aspect of the present invention, the optical synthesizer is configured to provide a plurality of phase coherent output light signals at different frequencies. The spacing between adjacent frequencies of the output light signals can be approximately equal to a frequency of a local oscillator of the optical synthesizer.

Since the sequentially transmitted lidar signals are different in frequency, the order in which the signals were transmitted is apparent to the receiver. Ambiguity is thus mitigated by frequency tagging a series of output light signals.

The optical synthesizer can comprises a non-linear mixer, such that a desired series of frequency outputs is obtained therefrom. The laser source(s) can comprises at least one femtosecond laser.

The scope of the invention is defined by the claims, which are incorporated into this section by reference. A more complete understanding of embodiments of the present invention will be afforded to those skilled in the art, as well as a realization of additional advantages thereof, by a consideration of the following detailed description of one or more embodiments. Reference will be made to the appended sheets of drawings that will first be described briefly.

### BRIEF DESCRIPTION OF THE DRAWINGS

FIG. 1 is a block diagram showing a contemporary lidar system in operation and illustrating the long duty cycle thereof;

FIG. 2 is a block diagram showing a lidar system in accordance with an exemplary embodiment of the present invention and illustrating the short duty cycle thereof;

FIG. 3 is a block diagram showing the short duty cycle transmitter of FIG. 2 in further detail;

FIG. 4. is a block diagram showing the short duty cycle receiver of FIG. 2 in further detail;

FIG. 5 is a plan view of the sensor array of FIG. 4; and

FIG. 6 is a chart showing an exemplary frequency spectrum of an output of the optical synthesizer of FIG. 3.

Embodiments of the present invention and their advantages are best understood by referring to the detailed description that follows. It should be appreciated that like reference numerals are used to identify like elements illustrated in one or more of the figures.

### DETAILED DESCRIPTION

A system and method for mitigating undesirable ambiguity in lidar systems is disclosed. Mitigating ambiguity facilitates the use of shorter duty cycles. Because of the shorter duty cycles, more lidar pulses can be transmitted in a given amount of time, thus resulting in the ability to form more detailed lidar range images.

According to one aspect of the present invention, ambiguity is mitigate by tagging the transmitted lidar pulses such that each individual return pulse can be recognized. For example, the transmitted lidar pulses may be tagged by transmitting them at different frequencies with respect to one another. Thus, when a return pulse is received, there is no ambiguity regarding which transmitted pulse the return pulse results from. The return pulses will have substantially the same frequency as the transmitted pulses, unless Doppler effect become substantial. Thus, the round trip time (and consequently the distance to the target) of the pulse can be reliably determined.

According to one aspect of the present invention, a plurality of light frequencies are produced. Lidar pulses are transmitted at these frequencies. The greater the number of frequencies, the shorter the duty cycle of the lidar system can be and the more detail that can be provided thereby. A large number of frequencies can be formed by an optical synthesizer, for example.

The number of frequencies can be limited by the amount of Doppler shift that is expected due to moving targets. The number of frequencies used can be dynamically adjusted, depending upon the amount of Doppler shift experienced. Thus, when more Doppler shift is experienced, then fewer frequencies and longer duty cycles can be used to prevent ambiguity in the recognition of received lidar pulses. Such dynamic adjustment can be either manually or automatically applied.

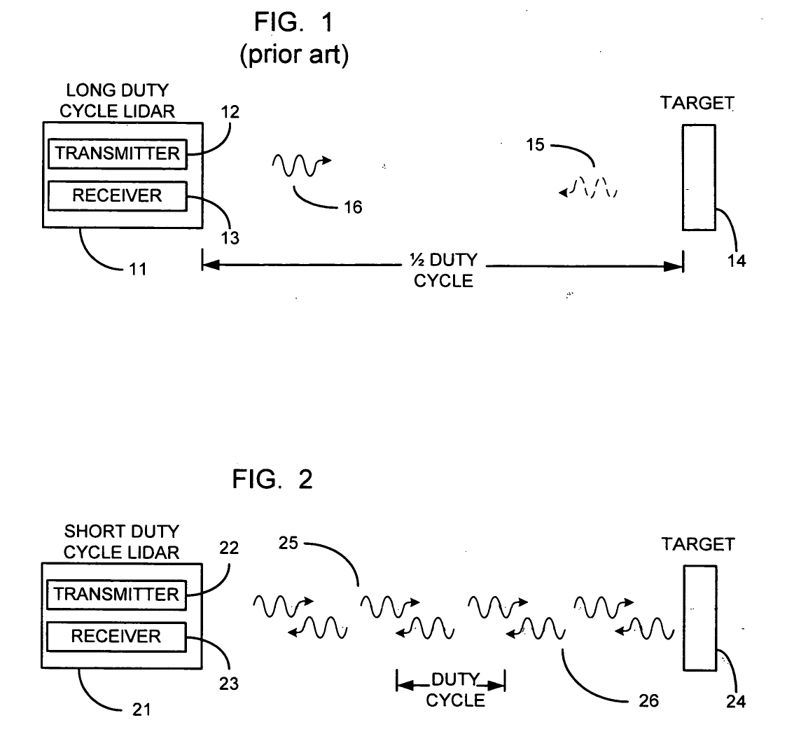

FIG. 1 shows a contemporary long duty cycle lidar system 11. Long duty cycle lidar system 11 comprises a transmitter 12 and a receiver 13. Transmitter 12 transmits a lidar pulse 16. As discussed above, in order to prevent ambiguity among return lidar pulses, contemporary lidar system 11 must wait for a return pulse 15 that was reflected from a target 14 to be received by receiver 13 before transmitting a subsequent lidar pulse.

Thus, an undesirably long duty cycle is defined. The duty cycle is the time that it takes the pulse to travel from transmitter 12 to target 14 and then back to receiver 13. Thus the distance between contemporary long duty cycle lidar system 11 and target 14 defines ½ of the duty cycle, as shown in FIG. 1. This long duty cycle limits the number of lidar pulses that can be transmitted in a given amount of time. The long duty cycle thus also limits the resolution of any lidar range images that can be formed by contemporary lidar system 12 in a given amount of time.

FIG. 2 shows a plurality of tagged lidar pulses 25 being transmitted from a transmitter 22 of a short duty cycle lidar system 21, according to one embodiment of the present invention. Since lidar pulses 25 are tagged such that they can be recognized by a receiver 23, there is no need to wait for a reflected lidar pulse 26 to be received before another lidar pulse 25 is transmitted.

If two lidar pulses are reflected by targets such that the lidar pulse transmitted first arrives at receiver 23 second, there is no ambiguity because of the tagging. Since the two lidar pulses have different frequencies, for example, it is easy to determine which reflected lidar pulse 26 was the result of which transmitted lidar pulse 25. As mentioned above, an earlier transmitted lidar pulse can arrive at a receiver later than a subsequently transmitted lidar pulse if the earlier transmitted lidar pulse is reflected by a target that is further away from the lidar system than a target that reflects the subsequent lidar pulse.

According to one aspect of the present invention, a plurality of lidar pulses are transmitted after a first lidar pulse is transmitted and before the first lidar pulse is received. The number of lidar pulses transmitted after the first lidar pulse is transmitted and before the first lidar pulse is received depends, among other things, upon how many lidar pulses can be uniquely tagged and subsequently recognized, so as to substantially mitigate ambiguity.

When frequency tagging is used, the number of lidar pulses transmitted after a first lidar pulse is transmitted and before the first lidar pulse is received depends upon the number of different frequencies that can be produced by the transmitter and also upon the number of different frequencies that can be reliably recognized by the receiver. When an optical synthesizer is used to produce the different frequencies, a larger number of frequencies is possible. For example, contemporary optical synthesizers are capable of producing greater than one million discrete frequencies.

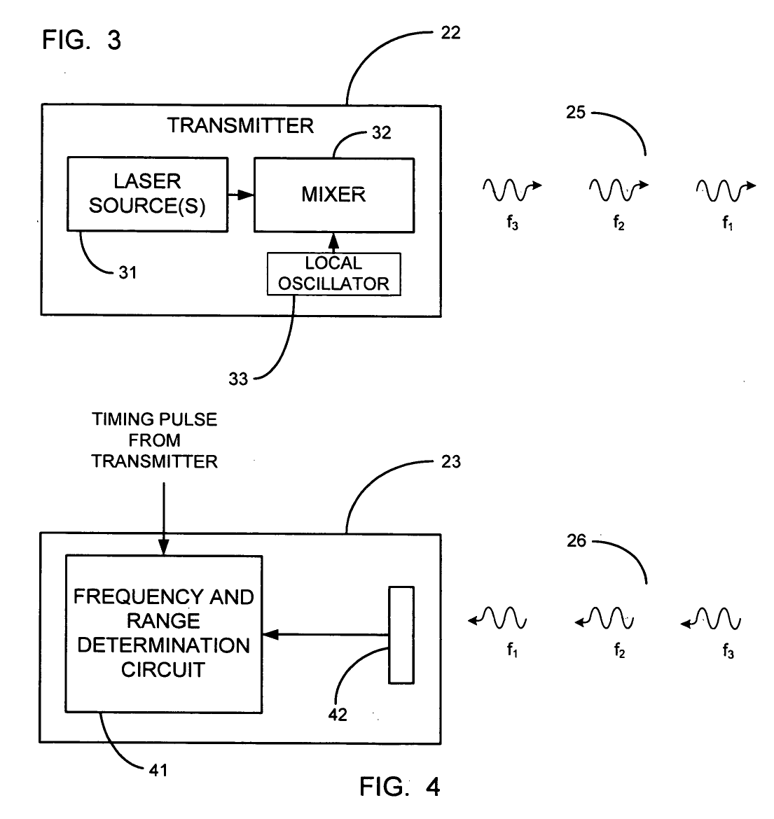

FIG. 3 shows the lidar transmitter of FIG. 2, which comprises an optical synthesizer according to one embodiment of the present invention. The optical synthesizer is defined by at least one laser source 31 that provides at least one laser beam to a non-linear mixer 32. Laser source(s) can provide two or more laser beams to mixer 32, each having a different frequency. A local oscillator 33 also provides a signal to mixer 32. Local oscillator can be a radio frequency (rf) oscillator, such as a microwave oscillator. Mixer 32 uses non-linear mixing to produce a plurality of harmonic sum and difference frequencies, according to well known principles. As those skilled in the art will appreciate, transmitter 22 can optionally further comprise an intensity conditioner, a wavelength conditioner, a polarization conditioner, and/or a beam propagation system.

The optical synthesizer defined by laser source(s) 31, mixer 32, and local oscillator 33 produces a plurality of pulses 25, each of which has a different frequency, so as to define a comb of frequencies (as shown in FIG. 6). Since pulses 25 have different frequencies (f₁, f₂, f₃, etc.), a plurality of such pulses can be transmitted in a short period of time (less than the round trip time for the pulse that travels the furthest) without introducing undesirable ambiguity. By modulating the output of the optical synthesizer, the frequency of each pulse can be selected.

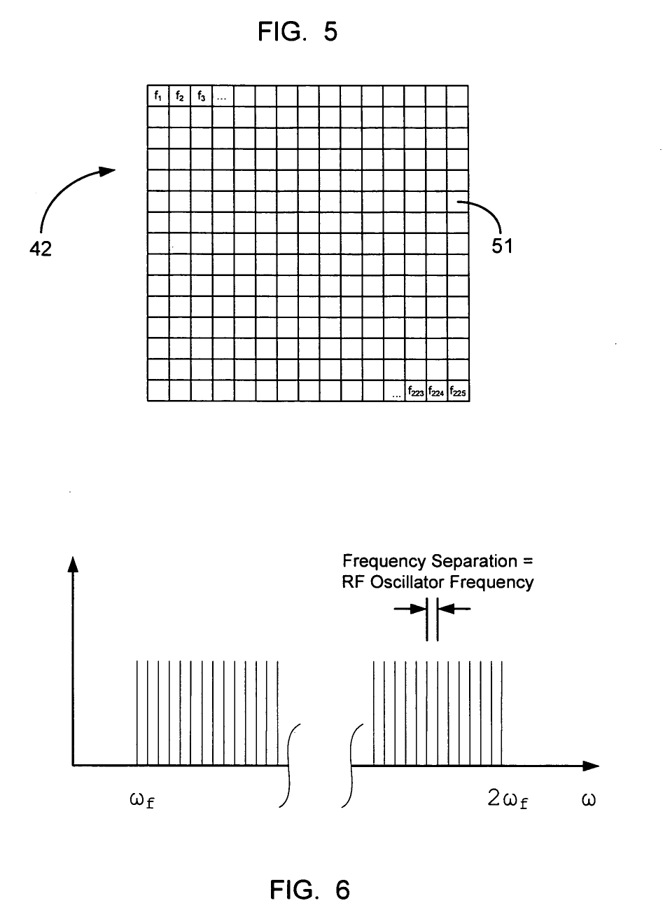

FIG. 4 shows the lidar receiver of FIG. 2, which comprises a sensor array 42 for detecting return lidar pulses 26. As shown in FIG. 5 and discussed in detail below, sensor array 42 comprises a plurality of individual sensor elements or pixels, each of which is sensitive to a particular frequency. Thus, determining which pixel senses a return lidar pulse determines the frequency of the lidar pulse.

Sensor array 42 provides an output to frequency and range determination circuit 41. The output is representative of the frequency of a return lidar pulse 26. Frequency and range determination circuit 41 determines the frequency of the return lidar pulse 26, which is dependent upon which pixel sensed the return lidar pulse. Frequency and range determination circuit 41 also receives information from transmitter 22 that is indicative of the time at which each pulse is transmitted. Frequency and range determination circuit 41 uses the information from transmitter 22 to determine the round trip time of each return lidar pulse 26 and thus the distance to the target. A scanned series of such pulses can be used to form a lidar range image of the scene that is being scanned.

FIG. 5 better shows sensor array 42. Sensor array 42 is comprised of a plurality of individual sensor elements or pixels 51. The number of pixels corresponds generally to the number of frequencies of lidar pulses transmitted by transmitter 22. Only 255 pixels 51 are shown in FIG. 5 for simplicity. Sensor array 42 can comprise many more pixels, e.g., greater than one million pixels. Each pixel is uniquely responsive to one of the frequencies of the transmitted lidar pulses 25. For example the first pixel 51 in the upper left hand corner of sensor array 42 can be responsive to frequency f₁ of transmitted lidar pulses 25 and the last pixel 51 in the lower right hand corner of sensor array 42 can be responsive to frequency f₂₅₅ of transmitted lidar pulses 42.

Such responsiveness may be the result of forming the band gaps of the pixels such that only light of the predetermined frequency affects each pixel. Alternatively, each pixel 51 may have a dedicated band pass filter, such that each pixel 51 is only responsive to the frequency of the band pass filter.

The use of such a multi-element sensor array is by way of example only and not by way of limitation. Those skilled in the art will appreciated that other methods for determining the frequency of return lidar pulses may alternatively be used.

FIG. 6 shows an exemplary frequency spectrum of an output from an optical synthesizer. The range of frequencies extends from a lowest frequency corresponding to a fundamental frequency ω_{f} to a highest frequency corresponding to a second harmonic frequency 2ω_{f}. The frequency separation between adjacent frequencies is equal to the local oscillator frequency. Thus, the optical oscillator forms a frequency comb that contains components suitable for sequential transmission in a lidar system. The multifrequency output of the optical oscillator can be modulated such that different frequency pulses are sequentially provided, according to well known principles.

As such, according to one or more embodiments of the present invention, ambiguity in lidar systems is substantially mitigated such that shorter duty cycles can be used and more detailed lidar range images can be provided.

Embodiments described above illustrate but do not limit the invention. It should also be understood that numerous modifications and variations are possible in accordance with the principles of the present invention. Accordingly, the scope of the invention is defined only by the following claims.

We claim:

1. A lidar system comprising an optical synthesizer configured to provide a plurality of output light signals, wherein each output light signal is at a different frequency so as to mitigate ambiguity associated with received light signals and thus reduce the duration of a duty cycle of the lidar system.

2. The lidar system of claim 1, wherein the optical synthesizer comprises:
at least one laser source;
a local radio frequency oscillator; and
a mixer configured to mix the outputs of the laser source(s) and the local radio frequency oscillator in a manner that forms the plurality of output light signals.

3. The lidar system of claim 1, wherein the optical synthesizer comprises:
at least one laser source;
a local microwave oscillator; and
a mixer configured to mix the outputs of the laser source(s) and the local microwave oscillator in a manner that forms the plurality of output light signals.

4. The lidar system of claim 1, wherein the optical synthesizer is configured to provide a plurality of phase coherent output light signals at different frequencies.

5. The lidar system of claim 1, wherein a spacing between adjacent frequencies of the output light signals is approximately equal to a frequency of a local oscillator of the optical synthesizer.

6. The lidar system of claim 1, wherein ambiguity is mitigated by frequency tagging a series of output light signals.

7. The lidar system of claim 1, wherein the optical synthesizer comprises a non-linear mixer.

8. The lidar system of claim 1, wherein the optical synthesizer comprises a femtosecond laser.

9. The lidar system of claim 1, wherein the optical synthesizer partially defines a transmitter, the transmitter comprising at least one of an intensity conditioner, a wavelength conditioner, a polarization conditioner, and a beam propagation system.

10. A lidar system comprising:
a transmitter comprising means for providing a plurality of output light signals at different frequencies; and
a receiver configured to receive reflected light signal at approximately the different frequencies.

11. A lidar system comprising:
a transmitter, the transmitter comprising means for tagging a plurality of output light signals; and
a receiver configured to receive the tagged signals.

12. A lidar receiver comprising an optical synthesizer configured to provide a plurality of output light signals, wherein each output light signal is at a different frequency.

13. A lidar receiver comprising:
a sensor array having a plurality of pixels, each pixel being responsive to a predetermined frequency of light; and
a frequency and range determination circuit receiving an output from the sensor array.

14. A sensor array comprising a plurality of pixels, each pixel being responsive to a predetermined frequency of light.

15. A method of operating lidar, the method comprising tagging a sequence of transmitted light signals to mitigate ambiguity in return signals formed therefrom.

16. A method of operating a lidar system, the method comprising providing a plurality of output light signals, wherein each output light signal is at a different frequency so as to mitigate ambiguity associated with received light signals and thus reduce the duration of a duty cycle of the lidar system.

17. The method of claim 16, wherein providing a plurality of output light signals comprises:
communicating an output of at least one laser source to a mixer;
communicating an output of a local radio frequency oscillator to the mixer; and
mixing the outputs of the laser source(s) and the radio frequency oscillator to form the plurality of output light signals.

18. The method of claim 16, wherein providing a plurality of output light signals comprises:
communicating an output of at least one laser source to a mixer;
communicating an output of a local microwave oscillator to the mixer; and
mixing the outputs of the laser source(s) and the microwave oscillator to form the plurality of output light signals.

19. The method of claim 16, wherein an optical synthesizer is configured to provide a plurality of phase coherent output light signals at different frequencies.

20. The method of claim 16, wherein a spacing between adjacent frequencies of the output light signals is approximately equal to a frequency of a local oscillator of an optical synthesizer.

21. The method of claim 16, wherein ambiguity is mitigated by frequency tagging a series of output light signals.

22. The method of claim 16, wherein the optical synthesizer comprises a non-linear mixer.

23. The method of claim 16, wherein the optical synthesizer comprises a femtosecond laser.
